(19) United States
(12) Patent Application Publication
(10) Pub. No.: US 2012/0107510 A1
(43) Pub. Date: May 3, 2012

(54) Liquid Crystal Polyester Liquid Composition

(75) Inventors: Toyonari ITO, Tsukuba-shi (JP); Shohei AZAMI, Tsukuba-shi (JP); Changbo SHIM, Tsukuba-shi (JP)

(73) Assignee: SUMITOMO CHEMICAL COMPANY, LIMITED, Tokyo (JP)

(21) Appl. No.: 13/280,563

(22) Filed: Oct. 25, 2011

(30) Foreign Application Priority Data
Oct. 27, 2010 (JP) P2010-240389

(51) Int. Cl. C09K 19/06; B05D 3/00

(52) U.S. Cl. 427/385.5; 252/299.6

(57) ABSTRACT

The present invention aims at providing a liquid composition which contains a liquid crystal polyester, a solvent and an inorganic filler and which provides a liquid crystal polyester-impregnated fiber sheet that is less likely to cause a decrease in strength even when exposed to high humidity; according to a preferred embodiment, the liquid composition is prepared by mixing a liquid crystal polyester, a solvent, and a surface treated silica containing silica having a volume average particle diameter of from 0.1 to 1.5 μm, the surface of which is treated with a silane compound having at least one kind of group selected from the group consisting of a methacryloyloxy group, a phenyl group, a vinyl group and an epoxy group.

### BACKGROUND OF THE INVENTION

1. Field of the Invention

The present invention relates to a liquid composition comprising a liquid crystal polyester, a solvent and an inorganic filler.

2. Related Background Art

A liquid crystal polyester has high heat resistance and low dielectric loss; therefore, as a resin-impregnated fiber sheet for use in an insulating layer of a printed circuit board, a study has been made of a liquid crystal polyester-impregnated fiber sheet obtained by impregnating a fiber sheet with a liquid crystal polyester. Also, as a method of its production, a study has been made of a method in which the fiber sheet is impregnated with a liquid composition containing a liquid crystal polyester and a solvent and the solvent is then removed. Inclusion of inorganic fillers in the liquid composition has further been studied: see, for example, JP-A-2004-244621, JP-A-2005-194406, JP-A-2006-1959 and JP-A-2007-146139. Specifically, JP-A-2004-244621, JP-A-2005-194406 and JP-A-2006-1959 disclose that the liquid composition is allowed to contain inorganic fillers such as silica, aluminum hydroxide and calcium carbonate. JP-A-2007-146139 discloses that the liquid composition is allowed to contain inorganic fillers such as silica, alumina, titanium oxide, barium titanate, strontium titanate, aluminum hydroxide and calcium carbonate.

### SUMMARY OF THE INVENTION

The liquid crystal polyester-impregnated fiber sheet obtained using a conventional liquid composition comprising a liquid crystal polyester, a solvent and an inorganic filler has a problem that its strength is likely to decrease when exposed to high humidity. Therefore, an object of the present invention is to provide a liquid composition which comprises a liquid crystal polyester, a solvent and an inorganic filler and which provides a liquid crystal polyester-impregnated fiber sheet that is less likely to cause a decrease in strength even when exposed to high humidity.

In order to achieve the above object, the present invention provides a liquid composition comprising a liquid crystal polyester, a solvent, and a surface treated silica, the surface treated silica is a silica which has a volume average particle diameter of from 0.1 to 1.5 μm, the surface of which is treated with a silane compound having at least one kind of group selected from the group consisting of a methacryloyloxy group, a phenyl group, a vinyl group and an epoxy group. According to the present invention, there is also provided a method for producing a liquid crystal polyester-impregnated fiber sheet, the method comprising impregnating a fiber sheet with the liquid composition, and then removing the solvent.

It is possible to obtain a liquid crystal polyester-impregnated fiber sheet that is less likely to cause a decrease in strength even when exposed to high humidity by using the liquid composition of the present invention.

### BRIEF DESCRIPTION OF THE DRAWINGS

FIG. 1 shows a perspective view of a perspective view of a liquid crystal polyester-impregnated fiber sheet according to a preferred embodiment.

### DESCRIPTION OF THE PREFERRED EMBODIMENTS

The liquid crystal polyester is preferably a polyester which exhibits mesomorphism in a molten state and which melts at a temperature of 450° C. or lower. The liquid crystal polyester may be a liquid crystal polyesteramide, a liquid crystal polyester ether, a liquid crystal polyester carbonate, or a liquid crystal polyesterimide. The liquid crystal polyester is preferably a wholly aromatic liquid crystal polyester that is prepared by using only aromatic compounds as raw monomers.

Examples of the liquid crystal polyester include a liquid crystal polyester obtained by polymerizing (polycondensing) an aromatic hydroxycarboxylic acid and an aromatic dicarboxylic acid with at least one kind of compound selected from the group consisting of an aromatic diol, an aromatic hydroxyamine and an aromatic diamine; a liquid crystal polyester obtained by polymerizing plural kinds of aromatic hydroxycarboxylic acids; a liquid crystal polyester obtained by polymerizing an aromatic dicarboxylic acid with at least one kind of compound selected from the group consisting of an aromatic diol, an aromatic hydroxyamine and an aromatic diamine; and a liquid crystal polyester obtained by polymerizing a polyester such as polyethylene terephthalate with an aromatic hydroxycarboxylic acid. Here, the aromatic hydroxycarboxylic acid, the aromatic dicarboxylic acid, the aromatic diol, the aromatic hydroxyamine and the aromatic diamine, each independently, may be replaced by a polymerizable derivative thereof in its part or its entirety for use.

Examples of the polymerizable derivative of a compound having a carboxyl group, such as an aromatic hydroxycarboxylic acid or an aromatic dicarboxylic acid include a polymerizable derivative (ester) in which the carboxyl group has been converted into an alkoxycarbonyl group or an aryloxycarbonyl group, a polymerizable derivative (acid halide) in which the carboxyl group has been converted into a haloformyl group, and a polymerizable derivative (acid anhydride) in which the carboxyl group has been converted into an acyloxycarbonyl group. Examples of the polymerizable derivative of a compound having a hydroxyl group, such as an aromatic hydroxycarboxylic acid, an aromatic diol or an aromatic hydroxylamine include a polymerizable derivative (acylate) in which the hydroxyl group has been converted into an acyloxyl group through acylation. Examples of the polymerizable derivative of a compound having an amino group, such as an aromatic hydroxyamine or an aromatic diamine include a polymerizable derivative (acylate) in which the amino group has been converted into an acylamino group through acylation.

The liquid crystal polyester preferably has a repeating unit represented by the following formula (1) (which hereinafter may be sometimes referred to as “repeating unit (1)”). More preferably, it has the repeating unit (1), a repeating unit represented by the following formula (2) (which hereinafter may be sometimes referred to as “repeating unit (2)”) and a repeating unit represented by the following formula (3) (which hereinafter may be sometimes referred to as “repeating unit (3)”).

—O—Ar¹—CO—, (1)

—CO—Ar²—CO—, and (2)

—X—Ar³—Y—, (3)

wherein Ar¹ represents a phenylene group, a naphthylene group or a biphenylylene group, Ar² and Ar³ each independently represents a phenylene group, a naphthylene group, a biphenylylene group, or a group represented by the following formula (4), X and Y each independently represents an oxygen atom or an imino group, and hydrogen atoms existing in the group represented by Ar¹, Ar² or Ar³ each independently may be substituted with a halogen atom, an alkyl group or an aryl group.

—Ar⁴—Z—Ar⁵—, (4)

wherein Ar⁴ and Ar⁵ each independently represents a phenylene group or a naphthylene group, and Z represents an oxygen atom, a sulfur atom, a carbonyl group, a sulfonyl group or an alkylidene group.

Examples of the halogen atom include a fluorine atom, a chlorine atom, a bromine atom and an iodine atom. Examples of the alkyl group include a methyl group, an ethyl group, a n-propyl group, an isopropyl group, a n-butyl group, an isobutyl group, an s-butyl group, a t-butyl group, a n-hexyl group, a 2-ethylhexyl group, an n-octyl group and a n-decyl group, where the number of carbon atoms is preferably from 1 to 10. Examples of the aryl group include a phenyl group, a o-tolyl group, a m-tolyl group, a p-tolyl group, a 1-naphthyl group and a 2-naphthyl group, where the number of carbon atoms is preferably from 6 to 20. When the hydrogen atom in the group represented by Ar¹, Ar² or Ar³ is substituted with one of these groups, the number, each independently, is preferably 2 or less, and more preferably 1 or less, per the group represented by Ar¹, Ar² or Ar³.

Examples of the alkylidene group include a methylene group, an ethylidene group, an isopropylidene group, an n-butylidene group and a 2-ethylhexylidene group, where the number of carbon atoms is preferably from 1 to 10.

The repeating unit (1) is a repeating unit derived from a predetermined aromatic hydroxycarboxylic acid. The repeating unit (1) is preferably a repeating unit in which Ar¹ is a p-phenylene group (repeating unit derived from p-hydroxybenzoic acid), or a repeating unit in which Ar¹ is a 2,6-naphthylene group (repeating unit derived from 6-hydroxy-2-naphthoic acid).

The repeating unit (2) is a repeating unit derived from a predetermined aromatic dicarboxylic acid. The repeating unit (2) is preferably a repeating unit in which Ar² is a p-phenylene group (repeating unit derived from terephthalic acid), a repeating unit in which Ar² is a m-phenylene group (repeating unit derived from isophthalic acid), a repeating unit in which Ar² is a 2,6-naphthylene group (repeating unit derived from 6-hydroxy-2-naphthoic acid) or a repeating unit in which Ar² is a diphenylether-4,4′-diyl group (repeating unit derived from diphenylether-4,4′-dicarboxylic acid).

The repeating unit (3) is a repeating unit derived from a predetermined aromatic diol, aromatic hydroxylamine or aromatic diamine. The repeating unit (3) is preferably a repeating unit in which Ar³ is a p-phenylene group (repeating unit derived from hydroquinone, p-aminophenol or p-phenylenediamine) or a repeating unit in which Ar³ is a 4,4′-biphenylylene group (repeating unit derived from 4,4′-dihydroxybiphenyl, 4-amino-4′-hydroxybiphenyl or 4,4′-diaminobiphenyl).

The content of the repeating unit (1) is preferably 30 mol % or more, more preferably from 30 to 80 mol %, still preferably from 30 to 60 mol %, and most preferably from 30 to 40 mol %, based on the total amount of all repeating units (the value of the sum of amount (mol) equivalent to the amount of substance of each repeating unit determined by dividing the mass of each repeating unit constituting the liquid crystal polyester by formula weight of the each repeating unit). The content of the repeating unit (2) is preferably 35 mol % or less, more preferably from 10 to 35 mol %, still more preferably from 20 to 35 mol %, and most preferably from 30 to 35 mol %, based on the total amount of all the repeating units. The content of the repeating unit (3) is preferably 35 mol % or less, more preferably from 10 to 35 mol %, still more preferably from 20 to 35 mol %, and most preferably from 30 to 35 mol %, based on the total amount of the all repeating units. As the content of the repeating unit (1) increases, heat resistance, strength and rigidity will be improved more easily. However, if the content is too high, the solubility in solvent is likely to decrease.

The ratio of the content of the repeating unit (2) to that of the repeating unit (3) is preferably from 0.9/1 to 1/0.9, more preferably from 0.95/1 to 1/0.95, and most preferably from 0.98/1 to 1/0.98, as expressed in terms of [the content of repeating unit (2)]/[the content of repeating unit (3)] (mol/mol).

The liquid crystal polyester may comprise two or more kinds of repeating units (1) to (3) independently of one another. The liquid crystal polyester may also comprise a repeating unit other than repeating units (1) to (3), and its content is preferably 10 mol % or less, and more preferably 5 mol % or less, based on the total amount of all the repeating units.

The liquid crystal polyester preferably comprises, as the repeating unit (3), a repeating unit in which X and/or Y is/are imino group(s), that is, a repeating unit derived from the predetermined aromatic hydroxylamine and/or a repeating unit derived from the aromatic diamine since solubility in solvent is excellent. In particular, the liquid crystal polyester comprises, as the repeating unit (3), only a repeating unit in which X and/or Y is/are imino group(s) more preferably.

It is preferred that the liquid crystal polyester is produced by melt polymerization of a raw monomers corresponding to repeating units constituting the liquid crystal polyester, followed by solid phase polymerization of the obtained polymer (prepolymer). Thereby, a high-molecular weight liquid crystal polyester having high heat resistance as well as high strength and rigidity can be produced with satisfactory operability. The melt polymerization may be performed in the presence of a catalyst. Examples of the catalyst include metal compounds such as magnesium acetate, stannous acetate, tetrabutyltitanate, lead acetate, sodium acetate, potassium acetate and antimony trioxide; and nitrogen-containing heterocyclic compounds such as 4-(dimethylamino)pyridine and 1-methylimidazole. Among these catalysts, the nitrogen-containing heterocyclic compound is preferably used.

The flow initiation temperature of the liquid crystal polyester is preferably 250° C. or higher, more preferably from 250 to 350° C., and most preferably from 260 to 330° C. As the flow initiation temperature becomes higher, heat resistance as well as strength and rigidity will be improved more easily. However, if the flow initiation temperature is too high, the solubility in solvent is likely to decrease and viscosity of the liquid composition is likely to increase.

The flow initiation temperature is also called a flow temperature and is a temperature which exhibits a viscosity of 4,800 Pa·s (48,000 poise) when a liquid crystal polyester is melted, while heating at a rate of 4° C./minute, and extruded through a nozzle having an inner diameter of 1 mm and a length of 10 mm under a load of 9.8 MPa (100 kg/cm²) using a capillary rheometer. The flow initiation temperature serves as an indicator of the molecular weight of a liquid crystal polyester (see, “Liquid Crystal Polymer—Synthesis, Molding and Application”, ed. by Naoyuki Koide, p. 95, CMC Publishing CO., LTD., published Jun. 5, 1987).

The liquid composition of the present embodiment comprises a liquid crystal polyester, a solvent and an inorganic filler. It is possible to use, as the solvent, a solvent in which the liquid crystal polyester can be dissolved, specifically a solvent in which the liquid crystal polyester can be dissolved at a concentration ([liquid crystal polyester]/[liquid crystal polyester+solvent]) of 1% by mass or more at 50° C. through appropriate selection.

Examples of the solvent include halogenated hydrocarbons such as dichloromethane, chloroform, 1,2-dichloroethane, 1,1,2,2-tetrachloroethane and o-dichlorobenzene; halogenated phenols such as p-chlorophenol, pentachlorophenol and pentafluorophenol; ethers such as diethylether, tetrahydrofuran and 1,4-dioxane; ketones such as acetone and cyclohexanone; esters such as ethyl acetate and γ-butyrolactone; carbonates such as ethylene carbonate and propylene carbonate; amines such as triethylamine; nitrogen-containing heterocyclic aromatic compounds such as pyridine; nitriles such as acetonitrile and succinonitrile; amides such as N,N-dimethylformamide, N,N-dimethylacetamide and N-methylpyrrolidone; urea compounds such as tetramethylurea; nitro compounds such as nitromethane and nitrobenzene; sulfur compounds such as dimethyl sulfoxide and sulfolane; and phosphorus compounds such as hexamethylphosphoric acid amide and tri-n-butylphosphoric acid. Two or more kinds of these solvents may be used.

The solvent is preferably a solvent comprised of an aprotic compound, particularly an aprotic compound having no halogen atom, as the principal component since it has low corrosiveness and is easily handled. The aprotic compound preferably accounts for 50 to 100% by mass, more preferably 70 to 100% by mass, and most preferably 90 to 100% by mass of the entire solvent. It is preferred to use, as the aprotic compound, an amide such as N,N-dimethylformamide, N,N-dimethylacetamide or N-methylpyrrolidone since it easily dissolves the liquid crystal polyester.

The solvent is also preferably a solvent comprised of a compound having a dipole moment of from 3 to 5 as the principal component since it easily dissolves the liquid crystal polyester. The compound having a dipole moment of from 3 to 5 preferably accounts for 50 to 100% by mass, more preferably 70 to 100% by mass, and most preferably 90 to 100% by mass of the entire solvent. Particularly, it is preferred to use, as the aprotic compound, a compound having a dipole moment of from 3 to 5.

The solvent is also preferably a solvent comprised of a compound having a boiling point of 220° C. or lower at 1 atm as the principal component since it is easily removed. The compound having a boiling point of 220° C. or lower at 1 atm preferably accounts for 50 to 100% by mass, more preferably 70 to 100% by mass, and most preferably 90 to 100% by mass of the entire solvent. Particularly, it is preferred to use, as the aprotic compound, a compound having a boiling point of 220° C. or lower at 1 atm.

The content of the liquid crystal polyester in the liquid composition is preferably from 5 to 60% by mass, more preferably from 10 to 50% by mass, and most preferably from 15 to 45% by mass, based on the total amount of the liquid crystal polyester and the solvent. The content is appropriately adjusted so that a liquid composition having a desired viscosity is obtained and also a fiber sheet is impregnated with a desired amount of the liquid crystal polyester.

The liquid composition of the present embodiment comprises, as an inorganic filler, a surface treated silica obtained by surface treatment of silica with a silane compound having at least one kind of group selected from the group consisting of a methacryloyloxy group, a phenyl group, a vinyl group and an epoxy group. Thereby, it is possible to obtain a liquid crystal polyester-impregnated fiber sheet which is less likely to cause a decrease in strength even when exposed to high humidity.

The volume average particle diameter of silica to be subjected to the surface treatment is from 0.1 to 1.5 μm, preferably from 0.3 to 1 μm, and more preferably from 0.4 to 0.7 μm. When the volume average particle diameter of silica is too small, the aggregation of silica is likely to occur. In contrast, when the volume average particle diameter is too large, the strength is likely to decrease upon exposure of the liquid crystal polyester-impregnated fiber sheet to high humidity. The volume average particle diameter of silica can be measured by a laser diffraction method. Specifically, the volume average particle diameter of silica is a particle diameter corresponding to an accumulated fraction of 50% in the accumulated particle diameter distribution on a volume basis measured using a particle distribution analyzer of the laser diffraction type. The silica preferably has a general spherical shape.

The silane compound used as a surface treating agent of silica is preferably a silane compound in which at least one kind of group selected from the group consisting of a methacryloyloxy group, a phenyl group, a vinyl group and an epoxy group, or a group containing the group is bonded to a silicon atom. The other groups bonded to the silicon atom are leaving groups such as an alkoxyl group.

The silane compound is preferably a compound represented by the following formula (I):

R¹ₙSi(OR²)₄₋ₙ (I)

wherein R¹ represents a methacryloyloxyalkyl group, a phenyl group, a vinyl group or a glycidyloxyalkyl group; R² represents an alkyl group; n represents 1 or 2; when n is 1, three R²(s) may be the same as or different from each other; and when n is 2, two R¹(s) may be the same as or different from each other and two R²(s) may be the same as or different from each other.

Examples of the alkyl group in the methacryloyloxyalkyl group represented by R¹ include a methyl group, an ethyl group, a n-propyl group and an isopropyl group, and the number of carbon atoms is preferably from 1 to 4. Examples of the alkyl group in the glycidyloxyalkyl group represented by R¹ include a methyl group, an ethyl group, a n-propyl group and an isopropyl group, and the number of carbon atoms is preferably from 1 to 4. Examples of the alkyl group represented by R² include a methyl group, an ethyl group, a n-propyl group and an isopropyl group, and the number of carbon atoms is preferably from 1 to 4.

The surface treatment of silica may be performed by immersing silica in the silane compound or a solution thereof, or may be performed by spraying the silane compound or a solution thereof over silica, or may be performed by gasifying the silane compound or a solution thereof and bringing the gas into contact with silica. When the solution of the silane compound is used, removal of the solvent may be performed by separation of the solvent through filtration, or may be performed by evaporation of the solvent.

The concentration of the solution of the silane compound is preferably from 0.1 to 5% by mass. It is also preferred that the pH of the solution of the silane compound is adjusted within a range of from 3 to 5 by the addition of an acid such as acetic acid.

The content of the surface treated silica in the liquid composition is preferably from 2 to 50% by volume, and more preferably from 5 to 35% by volume, based on the total amount of the liquid crystal polyester and the surface treated silica. The content of the surface treated silica is appropriately adjusted so that a liquid crystal polyester-impregnated fiber sheet having desired performances can be obtained.

The liquid composition may comprise one or more kinds of additional components such as an additive and a resin other than the liquid crystal polyester.

Examples of the additive include a leveling agent, a defoaming agent, an antioxidant, an ultraviolet absorber, a flame retardant, a dye and a pigment. The content of the additive is preferably from 0 to 5 parts by mass based on 100 parts by mass of the liquid crystal polyester.

Examples of the resin other than the liquid crystal polyester include thermoplastic resins, excluding the liquid crystal polyester, such as polypropylene, polyamide, a polyester excluding the liquid crystal polyester, polyphenylene sulfide, polyetherketone, polycarbonate, polyethersulfone, polyphenyleneether and a modified compound thereof, and polyetherimide; elastomers such as a copolymer of glycidyl methacrylate and polyethylene; and thermocurable resins such as a phenol resin, an epoxy resin, a polyimide resin and a cyanate resin. The content of the resin is preferably from 0 to 20 parts by mass based on 100 parts by mass of the liquid crystal polyester.

The liquid composition can be prepared by mixing a liquid crystal polyester, a solvent, a surface treated silica and other components to be used optionally, all together or in the proper order. Specifically, it is preferred that the liquid composition is prepared by dissolving a liquid crystal polyester in a solvent to obtain a liquid crystal polyester solution, and then dispersing a surface treated silica in this liquid crystal polyester solution. In that case, the other components to be used optionally may be dissolved or dispersed in the solvent when, or before or after the liquid crystal polyester is dissolved in the solvent; or alternatively, they may be dissolved or dispersed in the liquid crystal polyester solution when, or before or after the surface treated silica is dispersed in the liquid crystal polyester solution.

It is possible to produce a liquid crystal polyester-impregnated fiber sheet, which is less likely to cause a decrease in strength even when exposed to high humidity, by impregnating a fiber sheet with the thus obtained liquid composition, and then removing the solvent from the liquid composition.

Examples of the fiber constituting the fiber sheet include inorganic fibers such as a glass fiber, a carbon fiber and a ceramics fiber; and organic fibers such as a liquid crystal polyester fiber, a polyester fiber including a liquid crystal polyester fiber, an aramid fiber and a polybenzazole fiber. Two or more kinds of these fibers may be used. Among these fibers, a glass fiber is preferred.

The fiber sheet may be a textile (woven fabric), a knit fabric or a nonwoven fabric. Among these, a textile is preferable since the dimensional stability of the liquid crystal polyester-impregnated fiber sheet is easily improved.

The thickness of the fiber sheet is preferably from 10 to 200 μm, more preferably from 10 to 150 μm, further preferably from 10 to 100 μm, particularly preferably from 10 to 90 μm, and most preferably from 10 to 70 μm.

The impregnation of a liquid composition into a fiber sheet is typically performed by immersing a fiber sheet in an immersion tank in which the liquid composition is charged. Then, it is possible to adjust the amount of the liquid crystal polyester to be adhered to the fiber sheet by appropriately adjusting the time of immersion of the fiber sheet and the rate of withdrawing the fiber sheet impregnated with the liquid composition from the immersion tank according to the content of the liquid crystal polyester in the liquid composition. The adhesion amount of this liquid crystal polyester is preferably from 30 to 80% by mass, and more preferably from 40 to 70% by mass, based on the total mass of the obtained liquid crystal polyester-impregnated fiber sheet

Then, the solvent in the liquid composition is removed from the fiber sheet impregnated with the liquid composition, thereby making it possible to obtain a liquid crystal polyester-impregnated fiber sheet. Removal of the solvent is preferably performed by evaporation of the solvent since the operation is simple. Examples of the removal method include heating, decompression and ventilation, and these methods may be used in combination.

After removal of the solvent, heat treatment may be further performed, and it is possible to further increase the molecular weight of a liquid crystal polyester by this heat treatment. This heat treatment is performed, for example, under an atmosphere of an inert gas such as nitrogen at 240 to 330° C. for 1 to 30 hours.

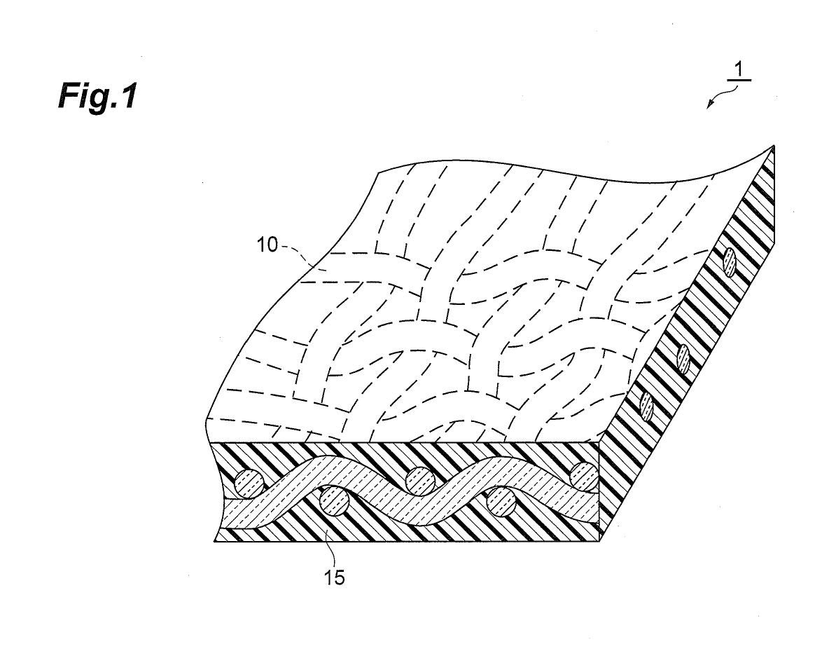

FIG. 1 shows a perspective view showing a liquid crystal polyester-impregnated fiber according to a preferred embodiment. As shown in FIG. 1, the liquid crystal polyester-impregnated fiber sheet 1 according to the preferred embodiment comprises a fiber sheet 10 and a liquid composition 15 with which it is impregnated. The fiber sheet 10 may consist of fiber bundles (multifilament) which cross to each other.

It is possible to obtain a liquid crystal polyester-impregnated fiber sheet with a conductor layer by optionally laminating a plurality of the thus obtained liquid crystal polyester-impregnated fiber sheets, and then forming a conductor layer on at least one face of the sheet.

The conductor layer may be formed on a liquid crystal polyester-impregnated fiber sheet or a laminate thereof by laminating a metal foil through bonding using an adhesive, welding using hot press and the like, or by coating metal particles using a plating method, a screen printing method, a sputtering method or the like. Examples of the metal constituting the metal foil or metal particles include copper, aluminum and silver; from the viewpoint of conductivity and cost, copper is preferably used.

The thus obtained liquid crystal polyester-impregnated fiber sheet with a conductor layer can be suitably used as a printed circuit board including the liquid crystal polyester-impregnated fiber sheet as an insulating layer by forming a predetermined wiring pattern on the conductor layer and optionally laminating a plurality of the sheets.

### EXAMPLES

### Measurement of Flow Initiation Temperature of Liquid Crystal Polyester

Using a Flow Tester (“Model CFT-500”, manufactured by Shimadzu Corporation), about 2 g of a liquid crystal polyester was filled into a cylinder attached with a die including a nozzle having an inner diameter of 1 mm and a length of 10 mm, and the liquid crystal polyester was melted while raising the temperature at a rate of 4° C./minute under a load of 9.8 MPa (100 kg/cm²), extruded through the nozzle, and then the temperature which exhibited a viscosity of 4,800 Pa·s (48,000 poise) was measured.

### Examples 1 to 6, Comparative Examples 1 to 3

### Production of Liquid Crystal Polyester

In a reactor equipped with a stirrer, a torque meter, a nitrogen gas introducing tube, a thermometer and a reflux condenser, 1,976 g (10.5 mol) of 6-hydroxy-2-naphthoic acid, 1,474 g (9.75 mol) of 4-hydroxyacetoanilide, 1,620 g (9.75 mol) of isophthalic acid and 2,374 g (23.25 mol) of acetic anhydride were charged. After replacing the gas within the reactor by a nitrogen gas, the temperature was raised from room temperature to 150° C. over 15 minutes under a nitrogen gas stream while stirring and the mixture was refluxed at 150° C. for 3 hours. Then, the temperature was raised from 150° C. to 300° C. over 2 hours and 50 minutes while distilling off the by-produced acetic acid and unreacted acetic anhydride. After maintaining at 300° C. for 1 hour, contents were taken out from the reactor and cooled to room temperature. The obtained solid was pulverized by a pulverizer to obtain a powdered prepolymer. The flow initiation temperature of the prepolymer was 235° C. Then, the temperature of this prepolymer was raised from room temperature to 223° C. under a nitrogen atmosphere over 6 hours, subjected to solid phase polymerization by maintaining at 223° C. for 3 hours and then cooled to obtain a powdered liquid crystal polyester. The flow initiation temperature of this liquid crystal polyester was 270° C.

### Silica

The following silica products were used as silica. The volume average particle diameter of silica is a diameter corresponding to an accumulated fraction of 50% in the accumulated particle size distribution on a volume basis measured using a particle size distribution analyzer of the laser diffraction type.

Silica (1): “MP-8FS” (volume average particle diameter of 0.5 μm) manufactured by TATSUMORI LTD.

Silica (2): “SO-C2” (volume average particle diameter of 0.4 μm) manufactured by Admatechs Co., Ltd.

Silica (3): “SFP-30M” (volume average particle diameter of 0.7 μm) manufactured by DENKI KAGAKU KOGYO K.K.

### Silane Compound

The following products were used as silane compounds.

Silane compound (1): 3-methacryloyloxypropyltrimethoxysilane (“KBM-503”, boiling point of 190° C., manufactured by Shin-Etsu Chemical Co., Ltd.)

Silane compound (2): phenyltrimethoxysilane (“KBM-103”, boiling point of 233° C., manufactured by Shin-Etsu Chemical Co., Ltd.)

Silane compound (3): vinyltrimethoxysilane (“Z-6300”, boiling point of 125° C., manufactured by Dow Corning Toray Co., Ltd.)

Silane compound (4): 3-glycidyloxypropyltrimethoxysilane (“Z-6040”, boiling point of 290° C., manufactured by Dow Corning Toray Co., Ltd.)

### Surface Treatment of Silica

To a 1 mass % aqueous acetic acid solution, a silane compound shown in Table 1 was added. After stirring (at 200 rpm) at room temperature for 1 hour, silica shown in Table 1 was added, followed by stirring (at 200 rpm) at room temperature for 1 hour. The use amount of the silane compound was set at the amount (% by mass) shown in Table 1 relative to silica. The obtained water dispersion of surface treated silica was filtered and the residue was dried in an oven at 100° C. for 20 minutes to obtain surface treated silica.

### Preparation of Liquid Composition

A liquid crystal polyester (2,200 g) was added to 7,800 g of N,N-dimethylacetamide and the mixture was heated at 100° C. for 2 hours to obtain a liquid crystal polyester solution. To this liquid crystal polyester solution, a surface treated silica (Examples 1 to 6) or an untreated silica (Comparative Examples 1 to 3) was added and then dispersed by a centrifugal deaerator (“HM-500”, manufactured by KEYENCE CORPORATION) to obtain a liquid composition. Here, the use amount of the surface treated silica was set at 10% by volume based on the total amount of the liquid crystal polyester and the surface treated silica.

### Production and Evaluation of Film

With respect to the liquid crystal polyester portion in a liquid crystal polyester-impregnated fiber sheet, a liquid crystal polyester film was produced and the strength retention ratios before and after high humidity treatment were evaluated in order to evaluate the strength retention ratios before and after the high humidity treatment. Specifically, a liquid composition was applied on a copper foil (“3EC-VLP”, thickness of 18 μm, manufactured by MITSUI MINING & SMELTING CO., LTD.), dried at 100° C. for 30 minutes under a nitrogen atmosphere and then subjected to heat treatment at 290° C. for 3 hours to obtain a copper clad laminate. Using an aqueous ferric chloride solution (manufactured by KIDA CO., LTD.: 40° Baume), the copper foil was removed from this copper clad laminate by etching to obtain a liquid polyester film. This liquid polyester film was subjected to high humidity treatment in a furnace at 121° C. at 2 atm under a relative humidity of 100% for 2 hours. Using a constant-rate-of-extension type tensile testing machine, the maximum point stresses of the film before and after the treatment were measured at a tension speed of 5 mm/minute in accordance with JIS C2151 (1990) and the strength retention ratio (maximum point stress of film after treatment/maximum point stress of film before treatment) was determined. The results are shown in Table 1.

TABLE 1

| | Silica | | | | | |
|---|---|---|---|---|---|---|
| | | Volume | | | | |
| | | average | | | | Film |
| | | particle | Silane compound | | | Strength |
| | | diameter | | | Use amount/Silica | retention |
| Examples | Kind | (μm) | Kind | Group | (% by mass) | ratio (%) |
| Examples 1 | (1) | 0.5 | (1) | Methacryloyloxy | 0.5 | 92 |
| Examples 2 | (1) | 0.5 | (1) | Methacryloyloxy | 2.6 | 90 |
| Examples 3 | (1) | 0.5 | (2) | Phenyl | 1.0 | 89 |
| Examples 4 | (2) | 0.4 | (1) | Methacryloyloxy | 1.0 | 92 |
| Examples 5 | (2) | 0.4 | (3) | Vinyl | 1.0 | 90 |
| Examples 6 | (3) | 0.7 | (4) | Epoxy | 1.0 | 88 |
| Comparative | (1) | 0.5 | — | — | — | 80 |
| Examples 1 | | | | | | |
| Comparative | (2) | 0.4 | — | — | — | 79 |
| Examples 2 | | | | | | |
| Comparative | (3) | 0.7 | — | — | — | 77 |
| Examples 3 | | | | | | |

What is claimed is:

1. A liquid composition comprising a liquid crystal polyester, a solvent, and a surface treated silica, the surface treated silica is a silica which has a volume average particle diameter of from 0.1 to 1.5 μm, the surface of which is treated with a silane compound having at least one kind of group selected from the group consisting of a methacryloyloxy group, a phenyl group, a vinyl group and an epoxy group.

2. The liquid composition according to claim 1, wherein the liquid crystal polyester is a liquid crystal polyester comprising a repeating unit represented by the following formula (1), a repeating unit represented by the following formula (2) and a repeating unit represented by the following formula (3):
—O—Ar¹—CO—; (1)
—CO—Ar²—CO—; and (2)
—X—Ar³—Y—; (3)
wherein Ar¹ represents a phenylene group, a naphthylene group or a biphenylylene group, Ar² and Ar³ each independently represents a phenylene group, a naphthylene group, a biphenylylene group, or a group represented by the following formula (4), X and Y each independently represents an oxygen atom or an imino group, and hydrogen atoms existing in the group represented by Ar¹, Ar² or Ar³ each independently may be substituted with a halogen atom, an alkyl group or an aryl group, and
—Ar⁴—Z—Ar⁵— (4)
wherein Ar⁴ and Ar⁵ each independently represents a phenylene group or a naphthylene group, and Z represents an oxygen atom, a sulfur atom, a carbonyl group, a sulfonyl group or an alkylidene group.

3. The liquid composition according to claim 2, wherein the liquid crystal polyester is a liquid crystal polyester comprising 30 to 80 mol % of a repeating unit represented by the formula (1), 10 to 35 mol % of a repeating unit represented by the formula (2) and 10 to 35 mol % of a repeating unit represented by the formula (3), based on the total amount of all repeating units constituting the liquid crystal polyester.

4. The liquid composition according to claim 2, wherein X and/or Y is/are imino group(s).

5. The liquid composition according to claim 1, wherein the solvent is a solvent containing 50% by mass or more of an aprotic compound.

6. The liquid composition according to claim 5, wherein the aprotic compound is an aprotic compound having no halogen atom.

7. The liquid composition according to claim 5, wherein the aprotic compound is an amide.

8. The liquid composition according to claim 1, wherein the silane compound is a compound represented by the following formula (I):
R¹ₙSi(OR²)₄₋ₙ (I)
wherein R¹ represents a methacryloyloxyalkyl group, a phenyl group, a vinyl group or a glycidyloxyalkyl group; R² represents an alkyl group; n represents 1 or 2; when n is 1, three R²(s) may be the same as or different from each other and; and when n is 2, two R¹(s) may be the same as or different from each other and two R²(s) may be the same as or different from each other.

9. The liquid composition according to claim 1, wherein the content of the liquid crystal polyester is from 5 to 60% by mass based on the total amount of the liquid crystal polyester and the solvent.

10. The liquid composition according to claim 1, wherein the content of the surface treated silica is from 2 to 50% by volume based on the total amount of the liquid crystal polyester and the surface treated silica.

11. A method for producing a liquid crystal polyester-impregnated fiber sheet, the method comprising impregnating a fiber sheet with the liquid composition according to claim 1, and then removing the solvent.
